(19) United States
(12) Patent Application Publication
(10) Pub. No.: US 2021/0250919 A1
(43) Pub. Date: Aug. 12, 2021

(54) APPARATUSES AND METHODS FOR USER EQUIPMENT (UE)-COORDINATION BASED RESOURCE ALLOCATION FOR SIDELINK COMMUNICATION

(71) Applicant: MediaTek Singapore Pte. Ltd., Singapore (SG)

(72) Inventors: Xuelong WANG, Beijing (CN); Tao CHEN, Beijing (CN)

(21) Appl. No.: 17/167,447

(22) Filed: Feb. 4, 2021

(30) Foreign Application Priority Data
Feb. 6, 2020 (CN) PCT/CN2020/074411
Jan. 29, 2021 (CN) 202110128295.0

(51) Int. Cl. H04W 72/04; H04W 72/02

(52) U.S. Cl. CPC H04W 72/042; H04W 72/02

(57) ABSTRACT

A UE operating as a Scheduler UE for SL communication is provided. The UE includes a wireless transceiver and a controller. The wireless transceiver performs wireless transmission and reception to and from a scheduled UE. The controller receives a request for resource allocation in a first Sidelink Control Information (SCI) from the scheduled UE via the wireless transceiver, and sends a second SCI including information of one or more first radio resources to the scheduled UE via the wireless transceiver in response to the request for resource allocation in the first SCI.

### CROSS REFERENCE TO RELATED APPLICATIONS

This Application claims priority of International Application No. PCT/CN2020/074411, filed on Feb. 6, 2020, the entirety of which is incorporated by reference herein. This Application claims priority of China Application No. 202110128295.0, filed on Jan. 29, 2021, the entirety of which is incorporated by reference herein.

### BACKGROUND OF THE APPLICATION

### Field of the Application

The application generally relates to mobile communications and, more particularly, to apparatuses and methods for User Equipment (UE)-coordination based resource allocation for Sidelink communication.

### Description of the Related Art

In a typical mobile communication environment, User Equipment (UE) (also called Mobile Station (MS)), such as a mobile telephone (also known as a cellular or cell phone), or a tablet Personal Computer (PC) with wireless communications capability, may communicate voice and/or data signals to one or more service networks. The wireless communications between the UE and the service networks may be performed using various Radio Access Technologies (RATs). These RATs have been adopted for use in various telecommunication standards to provide a common protocol that enables different wireless devices to communicate on a municipal, national, regional, and even global level. An example of an emerging telecommunication standard is the 5G New Radio (NR). It is designed to better support mobile broadband Internet access by improving spectral efficiency, reducing costs, and improving services.

In 5GNR, device-to-device (D2D) communication is supported to allow two or more UEs to directly communicate with one other. This D2D communication may also be referred to as Sidelink (SL) communication, and it may be applied to vehicular communication services which is also known as Vehicle-to-Everything (V2X) services. V2X collectively refers to communication technology via all interfaces with vehicles, including Vehicle-to-Vehicle (V2V), Vehicle-to-Infrastructure (V2I), Vehicle-to-Person (V2P), and Vehicle-to-Network (V2N). Since data transmission on an SL channel may not pass through a Base Station (BS), resource allocation among the UEs becomes a major issue in SL communication.

In release 16 of the 3GPP specifications for NR-based V2X, UE autonomous resource allocation (also referred to as mode-2 resource allocation) is proposed. The idea is to force a Transmission (Tx) UE to perform sensing on the shared radio resources configured by the BS before any transmission over the shared radio resources may be scheduled. However, the sensing-based UE behavior will inevitably result in unreliable and delayed SL transmission for the Tx UE. Moreover, the sensing-based UE behavior may have a negative impact on the power consumption of the Tx UE.

A solution is sought.

### BRIEF SUMMARY OF THE APPLICATION

The present application proposes to enable UE-coordination based resource allocation for Sidelink communication, by using a request-and-grant based resource control over the radio resource allocation between the scheduler UE and the scheduled UE.

In a first aspect of the application, a UE operating as a Scheduler UE for SL communication is provided. The UE comprises a wireless transceiver and a controller. The wireless transceiver is configured to perform wireless transmission and reception to and from a scheduled UE. The controller is configured to receive a request for resource allocation in a first Sidelink Control Information (SCI) from the scheduled UE via the wireless transceiver, and send a second SCI comprising information of one or more first radio resources to the scheduled UE via the wireless transceiver in response to the request for resource allocation in the first SCI. In one embodiment, the request for resource allocation is a Scheduling Request (SR) and/or a Buffer Status Report (BSR), and the first radio resources are allocated for the scheduled UE to send Transmission (Tx) data to the scheduler UE or other UEs. In another embodiment, the controller further receives a BSR from the scheduled UE over the first radio resources via the wireless transceiver in response to the request for resource allocation being an SR. The controller sends a fourth SCI comprising information of one or more second radio resources to the scheduled UE via the wireless transceiver in response to receiving the BSR.

In a second aspect of the application, a method is provided, which comprises the following steps: receiving a request for resource allocation in a first SCI from a scheduled UE by a scheduler UE; and sending a second SCI comprising information of one or more first radio resources to the scheduled UE by a scheduler UE in response to the request for resource allocation in the first SCI. In one embodiment, the request for resource allocation is an SR and/or a BSR. In another embodiment, the method further includes receiving a BSR from the scheduled UE over the first radio resources in response to the request for resource allocation being an SR. The method also comprises sending a fourth SCI comprising information of one or more second radio resources to the scheduled UE in response to receiving the BSR.

In a third aspect of the application, a method is provided, which comprises the following steps: sending a request for resource allocation in a first SCI to a scheduler UE by a scheduled UE; and receiving a second SCI comprising information of one or more first radio resources from the scheduler UE by the scheduled UE in response to sending the request for resource allocation in the first SCI. In one embodiment, the request for resource allocation is an SR and/or a BSR. In another embodiment, the method further includes sending a BSR to the scheduler UE over the first radio resources in response to the request for resource allocation being an SR. The method also comprises receiving a fourth SCI comprising information of one or more second radio resources to the scheduled UE in response to sending the BSR.

Other aspects and features of the present application will become apparent to those with ordinarily skill in the art upon review of the following descriptions of specific embodiments of the apparatuses and the methods for UE-coordination based resource allocation for Sidelink communication.

### BRIEF DESCRIPTION OF THE DRAWINGS

The present application can be more fully understood by reading the subsequent detailed description and examples with references made to the accompanying drawings, wherein:

FIG. 1 is a schematic diagram illustrating a communication network according to an embodiment of the application;

FIG. 2 is a schematic diagram illustrating an SL communication environment according to an embodiment of the application;

FIG. 3 is a schematic diagram illustrating an SL communication environment according to another embodiment of the application;

FIG. 4 is a block diagram illustrating a UE according to an embodiment of the application;

FIG. 5 is a message sequence chart illustrating the UE-coordination based resource allocation for Sidelink communication according to an embodiment of the application;

FIG. 6 is a message sequence chart illustrating the UE-coordination based resource allocation for Sidelink communication according to another embodiment of the application;

FIG. 7 is a flow chart illustrating UE-coordination based resource allocation method for Sidelink communication according to an embodiment of the application; and

FIG. 8 is a flow chart illustrating UE-coordination based resource allocation method for Sidelink communication according to another embodiment of the application.

### DETAILED DESCRIPTION OF THE APPLICATION

The following description is made for the purpose of illustrating the general principles of the application and should not be taken in a limiting sense. It should be understood that the embodiments may be realized in software, hardware, firmware, or any combination thereof. The terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

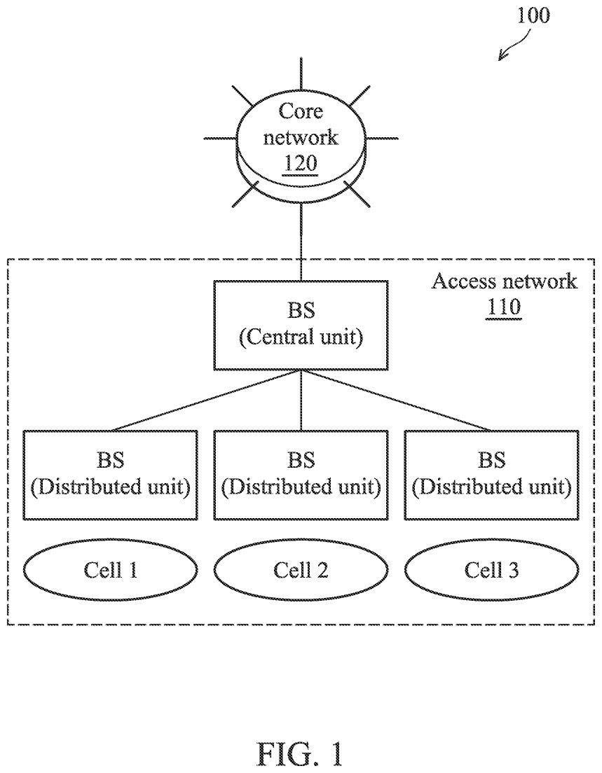

FIG. 1 is a schematic diagram illustrating a communication network according to an embodiment of the application.

As shown in FIG. 1, the communication network 100 may include an access network 110 and a core network 120. The access network 110 may be responsible for processing radio signals, terminating radio protocols, and connecting one or more UEs (not shown) with the core network 120. The core network 120 may be responsible for performing mobility management, network-side authentication, and interfaces with public/external networks (e.g., the Internet).

In one embodiment, the communication network 100 may be a 5G NR network, and the access network 110 and the core network 120 may be a Next Generation Radio Access Network (NG-RAN) and a Next Generation Core Network (NG-CN), respectively.

An NG-RAN may include one or more Base Stations (BSs), such as next generation NodeBs (gNBs), which support high frequency bands (e.g., above 24 GHz), and each gNB may further include one or more Transmission and Reception Points (TRPs), wherein each gNB or TRP may be referred to as a 5G BS. Some gNB functions may be distributed across different TRPs, while others may be centralized, leaving the flexibility and scope of specific deployments to fulfill the requirements for specific cases. For example, different protocol split options between central unit and distributed unit of gNB may be possible. In one embodiment, an optional Service Data Adaptation Protocol (SDAP) layer, and a Packet Data Convergence Protocol (PDCP) layer may be located in the central unit/gNB upper layers, while a Radio Link Control (RLC) layer, a Media Access Control (MAC) layer, and a Physical (PHY) layer may be located in the distributed units/gNB lower layers.

A 5G BS may form one or more cells with different Component Carriers (CCs) for providing mobile services to UEs. For example, a UE may camp on one or more cells formed by one or more gNBs or TRPs, wherein the cell on which the UE is camped may be referred to as a serving cell.

An NG-CN generally consists of various network functions, including Access and Mobility Function (AMF), Session Management Function (SMF), Policy Control Function (PCF), Application Function (AF), Authentication Server Function (AUSF), User Plane Function (UPF), and User Data Management (UDM). Each of above network functions may be implemented as by dedicated hardware, software, and/or as a virtualized function instantiated on an appropriate platform, e.g., a cloud infrastructure.

It should be understood that the communication network 100 described in the embodiment of FIG. 1 is for illustrative purposes only and is not intended to limit the scope of the application. For example, the RAT utilized by the communication network 100 may be a legacy technology, such as the Long Term Evolution (LTE) technology, or may be a future enhancement of the 5G NR technology, such as the 6G technology.

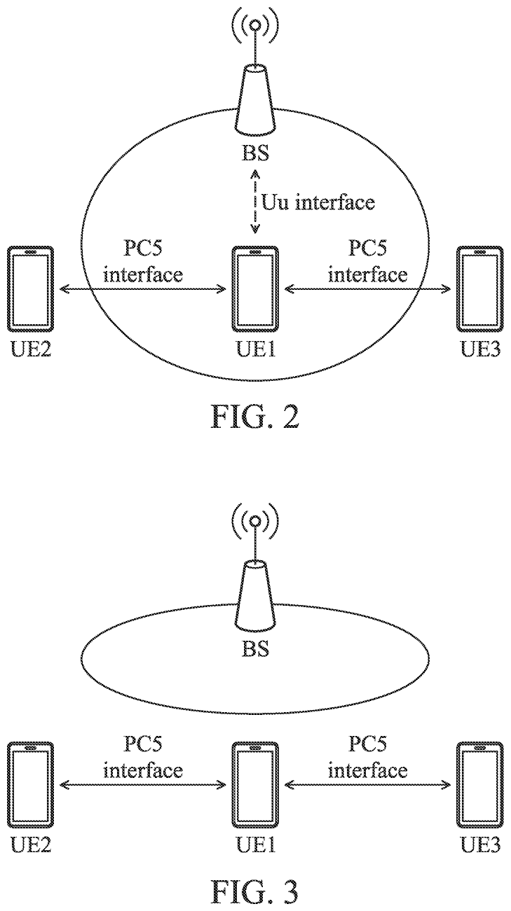

FIG. 2 is a schematic diagram illustrating an SL communication environment according to an embodiment of the application.

As shown in FIG. 2, UE1 is located within the radio coverage (in-coverage) of the BS and is able to communicative with the BS over the Uu interface, while UE2 and UE3 are out of the radio coverage (out-of-coverage) of the BS. In addition to supporting the Uu interface, UE1 also supports the PC5 interface for SL communication with UE2 and UE3.

Specifically, UE1 may operate as a scheduler UE (or called relay UE) which schedules/allocates the radio resources for UE2 and UE3 (or called scheduled UEs) according to the configuration received from the BS or pre-defined in the 3GPP specifications for NR-based V2X. As a relay, UE1 may forward traffic between UE2 and UE3, and/or forward traffic between UE2/UE3 and the BS. For example, UE1 may be configured as a Layer 2 relay or a Layer 3 relay. Alternatively, UE1 may not operate as a relay, and may initiate direct SL communication with either one or both of UE2 and UE3.

FIG. 3 is a schematic diagram illustrating an SL communication environment according to another embodiment of the application.

As shown in FIG. 3, none of UE1˜UE3 is located within the radio coverage of the BS, but SL communication between UE1˜UE3 is possible over the PC5 interface.

Specifically, UE1 may operate as a scheduler UE (or called relay UE) which schedules/allocates the radio resources for UE2 and UE3 (or called scheduled UEs) according to the configuration pre-defined in the 3GPP specifications for NR-based V2X or the configuration previously received from the BS when UE1 was camped on the BS. As a relay, UE1 may forward traffic between UE2 and UE3. For example, UE1 may be configured as a Layer 2 relay or a Layer 3 relay. Alternatively, UE1 may not operate as a relay, and may initiate direct SL communication with either one or both of UE2 and UE3.

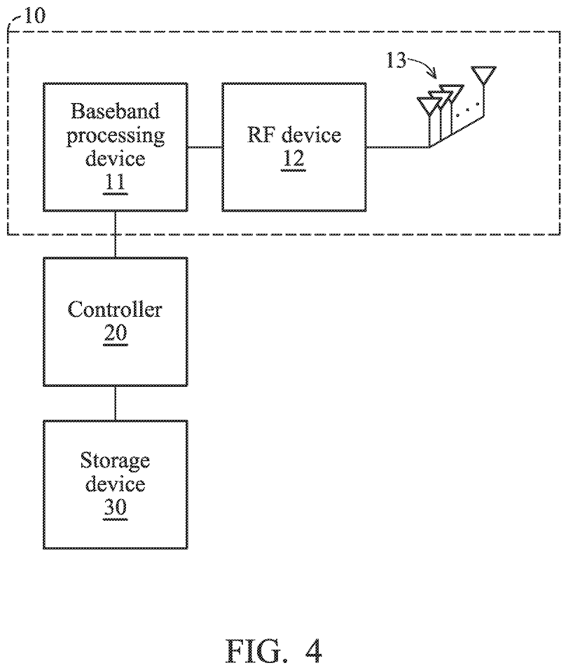

FIG. 4 is a block diagram illustrating a UE according to an embodiment of the application.

As shown in FIG. 4, a UE (e.g., a scheduler UE or scheduled UE) may include a wireless transceiver 10, a controller 20, and a storage device 30.

The wireless transceiver 10 is configured to perform wireless transmission and reception to and from other UEs and/or the BS(s) of the access network 110.

Specifically, the wireless transceiver 10 may include a baseband processing device 11, a Radio Frequency (RF) device 12, and antenna 13, wherein the antenna 13 may include an antenna array for beamforming.

The baseband processing device 11 is configured to perform baseband signal processing. The baseband processing device 11 may contain multiple hardware components to perform the baseband signal processing, including Analog-to-Digital Conversion (ADC)/Digital-to-Analog Conversion (DAC), gain adjusting, modulation/demodulation, encoding/decoding, and so on.

The RF device 12 may receive RF wireless signals via the antenna 13, convert the received RF wireless signals to baseband signals, which are processed by the baseband processing device 11, or receive baseband signals from the baseband processing device 11 and convert the received baseband signals to RF wireless signals, which are later transmitted via the antenna 13. The RF device 12 may also contain multiple hardware devices to perform radio frequency conversion. For example, the RF device 12 may comprise a mixer to multiply the baseband signals with a carrier oscillated in the radio frequency of the supported RAT(s).

The controller 20 may be a general-purpose processor, a Micro Control Unit (MCU), an application processor, a Digital Signal Processor (DSP), a Graphics Processing Unit (GPU), a Holographic Processing Unit (HPU), a Neural Processing Unit (NPU), or the like. The controller 20 may include various circuits and invoke different functional modules/circuits to perform features in the UE.

In another embodiment, the controller 20 may be incorporated into the baseband processing device 11, to serve as a baseband processor.

As will be appreciated by persons skilled in the art, in some embodiments, the circuits of the controller 20 will typically include transistors that are configured in such a way as to control the operation of the circuits in accordance with the functions and operations described herein. As will be further appreciated, the specific structure or interconnections of the transistors will typically be determined by a compiler, such as a Register Transfer Language (RTL) compiler. RTL compilers may be operated by a processor upon scripts that closely resemble assembly language code, to compile the script into a form that is used for the layout or fabrication of the ultimate circuitry. Indeed, RTL is well known for its role and use in the facilitation of the design process of electronic and digital systems.

The storage device 30 may be a non-transitory machine-readable storage medium, including a memory, such as a FLASH memory or a Non-Volatile Random Access Memory (NVRAM), or a magnetic storage device, such as a hard disk or a magnetic tape, or an optical disc, or any combination thereof. The storage device 30 stores data, instructions, and/or program code of applications and communication protocols, to control the operation of the UE.

It should be understood that the components described in the embodiment of FIG. 4 are for illustrative purposes only and are not intended to limit the scope of the application. In some embodiments, the UE may include a display device (e.g., a Liquid-Crystal Display (LCD), a Light-Emitting Diode (LED) display, an Organic LED (OLED) display, or an Electronic Paper Display (EPD), etc.) and/or an Input/Output (I/O) device (e.g., one or more buttons, a keyboard, a mouse, a touch pad, a video camera, a microphone, and/or a speaker, etc.). In other embodiments, the UE may include a set of control modules that carry out functional tasks.

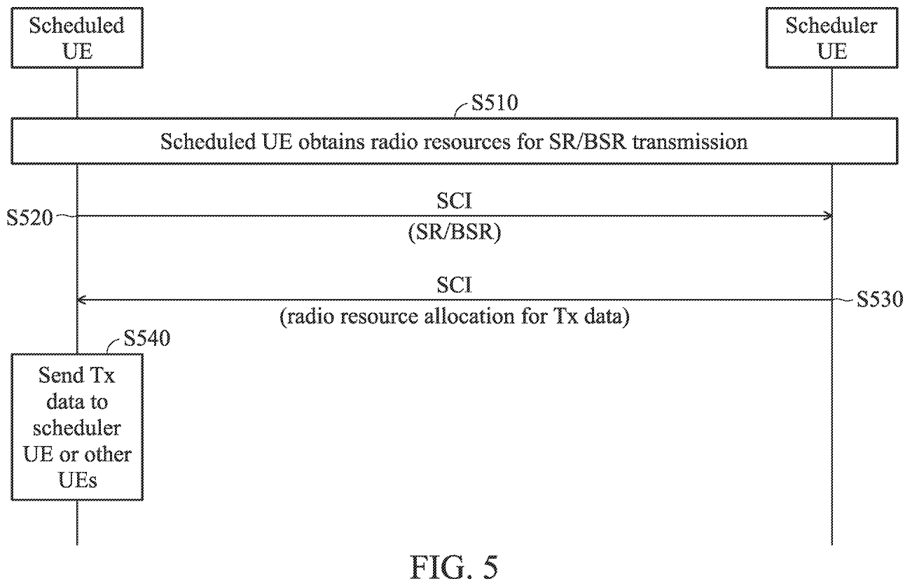

FIG. 5 is a message sequence chart illustrating the UE-coordination based resource allocation for Sidelink communication according to an embodiment of the application.

As shown in FIG. 5, the UE-coordination based resource allocation for Sidelink communication is realized by the cooperation of the scheduler UE and the scheduled UE.

In step S510, a Tx radio resource pool and a Reception (Rx) radio resource pool are configured from the scheduler UE to the scheduled UE.

Specifically, the Tx radio resource pool may include one or more radio resources for Scheduling Request (SR) and/or Buffer Status Report (BSR) transmission from the scheduled UE, while the Rx radio resource pool may include one or more radio resources for receiving radio resource allocation by the scheduled UE. The Rx radio resources may not be subject to sensing operation by the scheduled UE.

In one embodiment, the Tx radio resource pool and the Rx radio resource pool may be configured via a PC5 Radio Resource Control (RRC) message during a PC5 link establishment procedure, a PC5 RRC connection establishment procedure, or a Sidelink Radio Bearer (SLRB) setup procedure.

In another embodiment, the Tx radio resource pool and the Rx radio resource pool may be preconfigured (e.g., specified in the 3GPP specifications for NR-based V2X) and step S510 may be omitted.

In step S520, the scheduled UE sends a request for resource allocation in a first SCI to the scheduler UE. The first SCI could be a standalone SCI, and could be a new SCI having a new SCI format in some embodiments. Alternatively, the first SCI could be a first stage SCI of 2-stage SCI, or a second stage SCI of 2-stage SCI. For SCI-based SR/BSR transmission, the dedicated resource pool for SCI transmission can be (pre-)configured with or without sensing for resource selection.

Specifically, the request for resource allocation may be an SR and/or a BSR. For example, the SR may be indicated by an SR bit or an SR indicator for requesting resource allocation, and the BSR may be indicated by an SL BSR MAC Control Element (CE). In some embodiments, only a BSR is carried by the first SCI, i.e., an SR is omitted, but the SR can be implicitly indicated by the existence of BSR.

In addition to the fields of a conventional SL BSR MAC CE, additional information may be introduced in the SL BSR MAC CE to indicate the cast type for buffered data, the data characteristics (e.g. periodic or aperiodic data), the traffic pattern for periodic data, the Quality of Service (QoS) profile of the data, or any combination thereof.

From the PHY layer perspective, there are multiple options to realize the SR transmission from the scheduled UE to scheduler UE. In the first option, a newly defined physical channel (i.e. specific to SR transmission) may be used to carry the SR, wherein one bit is carried by each transmission occasion and a special sequence may be selected for the transmission (e.g. reuse the sequence for the Physical Uplink Control Channel (PUCCH)).

In the second option, the Physical Sidelink Feedback Channel (PSFCH) for feedback from Rx UE to Tx UE may be used to carry the SR. In this option, there are different alternatives to carry the SR. For the first alternative, one specific sequence may be used to transmit the SR (e.g., one SR bit) other than feedback information. That is, transmissions of the SR and Sidelink feedback information for one PSFCH transmission occasion are exclusive and identified by different sequences. For the second alternative, concurrent transmissions of the SR and Sidelink feedback information may be supported. For example, there may be two bits to be carried over the PSFCH, wherein one bit is used for Sidelink feedback information, and the other bit is used for SR. In this alternative, there may be only one signal sequence for the PSFCH. For the third alternative, a specific resource for PSFCH (e.g., the resource for ACK/NACK) may be used to carry the SR. For example, the basic transmission mechanism of PSFCH is maintained, while a dedicated PSFCH resource is allocated for SR transmission. For the fourth alternative, two different ACK/NACK time-frequency resources may be reserved for indicating the presence of the SR. The PSFCH-based SR resources may be determined implicitly according to at least one of the parameters, including the scheduler UE ID, the scheduled UE ID, and the group member ID.

Referring back to FIG. 5, in step S530, the scheduler UE sends a second SCI including information of one or more radio resources to the scheduled UE in response to the request for resource allocation in the first SCI.

Specifically, the second SCI is sent over the radio resources within the Rx radio resource pool configured in step S510. The second SCI could be a standalone SCI, and could be a new SCI having a new SCI format in some embodiments. Alternatively, the second SCI could be a first stage SCI of 2-stage SCI, or a second stage SCI of 2-stage SCI.

The allocated radio resources may be dedicatedly configured per destination or per destination index. For example, if the destination is the scheduler UE, the scheduler UE may be referred to as the Rx UE for the upcoming transmission from the scheduled UE (i.e., the Tx UE). Otherwise, if the destination is another scheduled UE, it may be referred to as the Rx UE, and the scheduler UE may configure the Rx radio resource pool for the Rx UE to prepare for reception of the upcoming transmission from the Tx UE. The Rx radio resource pool may refer to the radio resources to be used for the transmission from the Tx UE over the Physical Sidelink Shared Channel (PSSCH). Alternatively, the Rx radio resource pool may be preconfigured.

In step S540, the scheduled UE uses the allocated radio resources to send Tx data to the scheduler UE or other UEs.

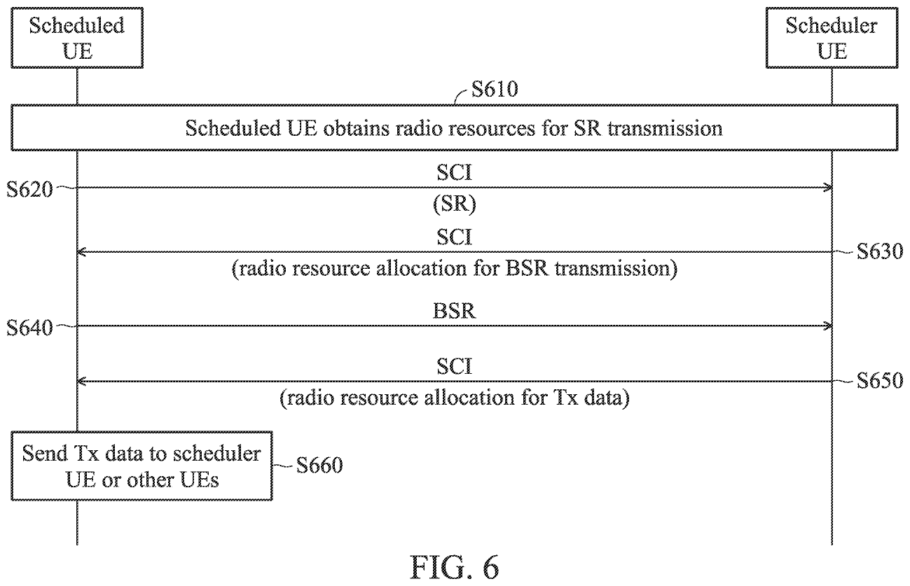

FIG. 6 is a message sequence chart illustrating the UE-coordination based resource allocation for Sidelink communication according to another embodiment of the application.

Similar to the embodiment of FIG. 5, the UE-coordination based resource allocation for Sidelink communication in FIG. 6 is realized by the cooperation of the scheduler UE and the scheduled UE.

In step S610, a Tx radio resource pool and an Rx radio resource pool are configured from the scheduler UE to the scheduled UE.

Specifically, the Tx radio resource pool may include one or more radio resources for SR and/or BSR transmission from the scheduled UE, while the Rx radio resource pool may include one or more radio resources for receiving radio resource allocation by the scheduled UE. The Rx radio resources may not be subject to sensing operation by the scheduled UE.

In one embodiment, the Tx radio resource pool and the Rx radio resource pool may be configured via a PC5 RRC message during a PC5 link establishment procedure, a PC5 RRC connection establishment procedure, or an SLRB setup procedure.

In another embodiment, the Tx radio resource pool and the Rx radio resource pool may be preconfigured (e.g., specified in the 3GPP specifications for NR-based V2X) and step S610 may be omitted.

In step S620, the scheduled UE sends an SR in a first SCI to the scheduler UE.

Specifically, the SR may be an SR bit or an SR indicator for requesting resource allocation. The first SCI could be a standalone SCI, and could be a new SCI having a new SCI format in some embodiments. Alternatively, the first SCI could be a first stage SCI of 2-stage SCI, or a second stage SCI of 2-stage SCI.

Please note that the detailed description regarding the SR transmission from the PHY layer perspective is similar to the embodiment of FIG. 5, and thus, it is omitted herein for brevity.

In step S630, the scheduler UE sends a second SCI including information of one or more first radio resources to the scheduled UE in response to receiving the SR in the first SCI.

For example, the information of the first radio resources may be an index corresponding to a particular resource configuration which is configured from scheduler UE to scheduled UE during the PC5 link establishment procedure, the PC5 RRC establishment procedure, or the SLRB setup procedure, or is preconfigured.

The second SCI could be a standalone SCI, and could be a new SCI having a new SCI format in some embodiments. Alternatively, the second SCI could be a first stage SCI of 2-stage SCI, or a second stage SCI of 2-stage SCI.

Alternatively, in step S630, the scheduler UE may also configure a new Rx radio resource pool for the scheduled UE to receive further resource allocation.

In step S640, the scheduled UE sends a BSR to the scheduler UE over the first radio resources.

Specifically, the BSR may be an SL BSR MAC CE. In contrast to the conventional SL BSR MAC CE defined in release 16 of the 3GPP specifications for NR-based V2X, additional information may be introduced in the SL BSR MAC CE to indicate the cast type for buffered data, the data characteristics (e.g. periodic or aperiodic data), the traffic pattern for periodic data, the QoS profile of the data, or any combination thereof.

In one embodiment, the BSR is carried by a third SCI. The third SCI could be a standalone SCI, and could be a new SCI having a new SCI format in some embodiments. Alternatively, the third SCI could be a first stage SCI of 2-stage SCI, or a second stage SCI of 2-stage SCI.

Alternatively, the BSR may be sent over the PSSCH as normal data. According to some embodiments, when the amount of data is less than size of an SL BSR, the scheduled UE may send the data, instead of the SL BSR, to the scheduler UE.

In step S650, the scheduler UE sends a fourth SCI including information of one or more second radio resources to the scheduled UE in response to receiving the BSR.

Specifically, the fourth SCI is sent over the radio resources within the Rx radio resource pool configured in step S610 or S630.

The fourth SCI could be a standalone SCI, and could be a new SCI having a new SCI format in some embodiments. Alternatively, the fourth SCI could be a first stage SCI of 2-stage SCI, or a second stage SCI of 2-stage SCI.

In step S660, the scheduled UE uses the second radio resources to send Tx data to the scheduler UE or other UEs.

The second radio resources may be dedicatedly configured per destination or per destination index. For example, if the destination is the scheduler UE, the scheduler UE may be referred to as the Rx UE for the upcoming transmission from the scheduled UE (i.e., the Tx UE). Otherwise, if the destination is another scheduled UE, it may be referred to as the Rx UE, and the scheduler UE may configure the Rx radio resource pool for the Rx UE to prepare for reception of the upcoming transmission from the Tx UE. The Rx radio resource pool may refer to the radio resources to be used for the transmission from the Tx UE over the PSSCH. Alternatively, the Rx radio resource pool may be preconfigured.

Please note that the radio resource allocation described in step S530 of FIG. 5 and/or step S650 of FIG. 6 may be dynamic allocation, semi-static allocation, or multiple allocation in one shot.

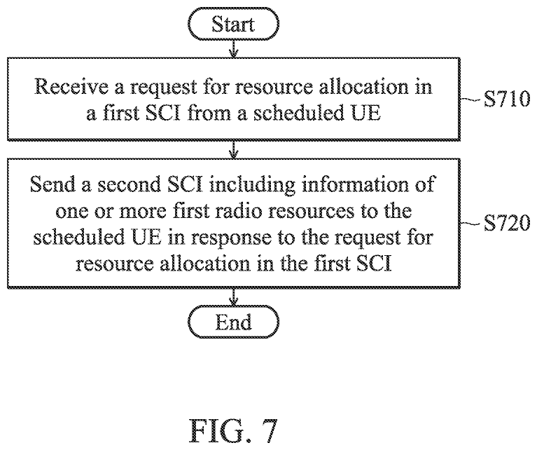

FIG. 7 is a flow chart illustrating UE-coordination based resource allocation method for Sidelink communication according to an embodiment of the application.

To begin with, the scheduler UE receives a request for resource allocation in a first SCI from a scheduled UE (step S710).

Next, the scheduler UE sends a second SCI including information of one or more first radio resources to the scheduled UE in response to the request for resource allocation in the first SCI (step S720).

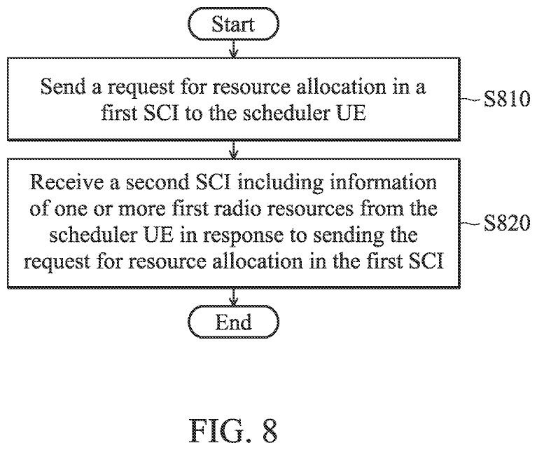

FIG. 8 is a flow chart illustrating UE-coordination based resource allocation method for Sidelink communication according to another embodiment of the application.

To begin with, the scheduled UE sends a request for resource allocation in a first SCI to the scheduler UE (step S810).

Next, the scheduled UE receives a second SCI including information of one or more first radio resources from the scheduler UE in response to sending the request for resource allocation in the first SCI (step S820).

In view of the forgoing embodiments, it will be appreciated that the present application realizes UE-coordination based resource allocation for Sidelink communication, by using a request-and-grant based resource control over the radio resource allocation between a scheduler UE and a scheduled UE. In particular, the SR and/or B SR mechanism may be used for the purpose of request-and-grant based resource control. Advantageously, the Tx UE will be using dedicated radio resources for sending Tx data to the Rx UE, and there's no need for the Tx UE to perform sensing on the shared radio resources any more. Therefore, the problems caused by UE autonomous resource allocation, such as unreliable and delayed SL transmission for the Tx UE, and inefficient power consumption of the Tx UE, may be solved.

While the application has been described by way of example and in terms of preferred embodiment, it should be understood that the application is not limited thereto. Those who are skilled in this technology can still make various alterations and modifications without departing from the scope and spirit of this application. Therefore, the scope of the present application shall be defined and protected by the following claims and their equivalents.

Use of ordinal terms such as “first”, “second”, etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

What is claimed is:

1. A User Equipment (UE), operating as a scheduler UE for Sidelink (SL) communication, the UE comprising:
a wireless transceiver, configured to perform wireless transmission and reception to and from a scheduled UE; and
a controller, configured to receive a request for resource allocation in a first Sidelink Control Information (SCI) from the scheduled UE via the wireless transceiver, and send a second SCI comprising information of one or more first radio resources to the scheduled UE via the wireless transceiver in response to the request for resource allocation in the first SCI.

2. The UE as claimed in claim 1, wherein the request for resource allocation is a Scheduling Request (SR) or a Buffer Status Report (BSR), and the first radio resources are allocated for the scheduled UE to send Transmission (Tx) data to the scheduler UE or other UEs.

3. The UE as claimed in claim 2, wherein the SR is an SR bit or an SR indicator for requesting resource allocation, and the BSR is an SL BSR Medium Access Control (MAC) Control Element (CE).

4. The UE as claimed in claim 2, wherein each of the first SCI and the second SCI is a standalone SCI, a first stage SCI of 2-stage SCI, or a second stage SCI of 2-stage SCI.

5. The UE as claimed in claim 1, wherein the controller further receives a BSR from the scheduled UE over the first radio resources via the wireless transceiver in response to the request for resource allocation being an SR, and sends a fourth SCI comprising information of one or more second radio resources to the scheduled UE via the wireless transceiver in response to receiving the BSR.

6. The UE as claimed in claim 1, wherein the controller further configures a Tx radio resource and a Reception (Rx) radio resource for the scheduled UE, and wherein the first SCI is received over the Tx radio resource and the second SCI is sent over the Rx radio resource.

7. The UE as claimed in claim 6, wherein the Tx radio resource and the Rx radio resource are configured via a PC5 Radio Resource Control (RRC) message during a PC5 link establishment procedure, a PC5 RRC connection establishment procedure, or an SL Radio Bearer (SLRB) setup procedure.

8. A method, comprising:
receiving a request for resource allocation in a first SCI from a scheduled UE by a scheduler UE; and
sending a second SCI comprising information of one or more first radio resources to the scheduled UE by a scheduler UE in response to the request for resource allocation in the first SCI.

9. The method as claimed in claim 8, wherein the request for resource allocation is an SR or a BSR, and the first radio resources are allocated for the scheduled UE to send Tx data to the scheduler UE or other UEs.

10. The method as claimed in claim 9, wherein the SR is an SR bit or an SR indicator for requesting resource allocation, and the BSR is an SL BSR MAC CE.

11. The method as claimed in claim 9, wherein each of the first SCI and the second SCI is a standalone SCI, a first stage SCI of 2-stage SCI, or a second stage SCI of 2-stage SCI.

12. The method as claimed in claim 8, further comprising:
receiving a BSR from the scheduled UE over the first radio resources by the scheduler UE in response to the request for resource allocation being an SR; and
sending a fourth SCI comprising information of one or more second radio resources to the scheduled UE by the scheduler UE in response to receiving the BSR.

13. The method as claimed in claim 8, further comprising:
configuring a Tx radio resource and an Rx radio resource for the scheduled UE;
wherein the first SCI is received over the Tx radio resource and the second SCI is sent over the Rx radio resource.

14. The method as claimed in claim 13, wherein the Tx radio resource and the Rx radio resource are configured via a PC5 RRC message during a PC5 link establishment procedure, a PC5 RRC connection establishment procedure, or an SLRB setup procedure.

15. A method, comprising:
sending a request for resource allocation in a first SCI to a scheduler UE by a scheduled UE; and
receiving a second SCI comprising information of one or more first radio resources from the scheduler UE by the scheduled UE in response to sending the request for resource allocation in the first SCI.

16. The method as claimed in claim 15, wherein the request for resource allocation is an SR or a BSR, and the first radio resources are allocated by the scheduler UE for the scheduled UE to send Tx data to the scheduler UE or other UEs.

17. The method as claimed in claim 16, wherein the SR is an SR bit or an SR indicator for requesting resource allocation, and the BSR is an SL BSR MAC CE.

18. The method as claimed in claim 16, wherein each of the first SCI and the second SCI is a standalone SCI, a first stage SCI of 2-stage SCI, or a second stage SCI of 2-stage SCI.

19. The method as claimed in claim 15, further comprising:
sending a BSR to the scheduler UE over the first radio resources by the scheduled UE in response to the request for resource allocation being an SR; and
receiving a fourth SCI comprising information of one or more second radio resources from the scheduler UE by the scheduled UE in response to sending the BSR.

20. The method as claimed in claim 15, further comprising:
receiving configurations of a Tx radio resource and an Rx radio resource from the scheduler UE by the scheduled UE;
wherein the first SCI is sent over the Tx radio resource and the second SCI is received over the Rx radio resource.

21. The method as claimed in claim 20, wherein the Tx radio resource and the Rx radio resource are configured via a PC5 RRC message during a PC5 link establishment procedure, a PC5 RRC connection establishment procedure, or an SLRB setup procedure.
